(19) United States
(12) Patent Application Publication
(10) Pub. No.: US 2008/0007902 A1
(43) Pub. Date: Jan. 10, 2008

(54) COUPLING UNIT AND ELECTRONIC DEVICE HAVING THE SAME

(75) Inventor: Tae-sang KIM, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/626,060

(22) Filed: Jan. 23, 2007

(30) Foreign Application Priority Data
Jul. 6, 2006 (KR) 2006-63594

(51) Int. Cl. G06F 1/16

(52) U.S. Cl. 361/680; 361/683

(57) ABSTRACT

An electronic device including a keyboard, and a printed circuit board provided in a rear portion of the keyboard. The electronic device includes a housing to support the keyboard and the printed circuit board, and a coupling unit to couple the keyboard and the printed circuit board, the coupling unit including a first coupling member coupled to the keyboard to be distanced from an electronic component mounted on the printed circuit board when the keyboard and the housing are coupled, a middle rod including a first coupling part provided at a first side thereof to be selectively coupled to the first coupling means, and a second coupling part provided at a second side thereof, and a second coupling member coupled with the second coupling part of the middle rod to couple the keyboard and the housing.

### CROSS-REFERENCE TO RELATED APPLICATIONS

This application claims priority under 35 U.S.C. §119(a) from Korean Patent Application No.2006-0063594, filed on Jul. 6, 2006, in the Korean Intellectual Property Office, the disclosure of which is incorporated herein in its entirety by reference.

### BACKGROUND OF THE INVENTION

1. Field of the Invention

The present general inventive concept relates to a coupling unit and an electronic device having the same, and more particularly, to a coupling unit and an electronic device having the same improved in a keyboard assembling configuration.

2. Description of the Related Art

Hereinafter, an electronic device comprises a television, a computer, etc. A portable computer comprises a monitor part provided with a flat display device such as an LCD panel, and a main body part supporting the monitor part and provided with various types of hardware and a keyboard. The portable computer may comprise a laptop computer, a notebook computer, etc.

Compared with a typical computer for which a monitor part and a main body part are separately manufactured, the portable computer has a size smaller than a typical desktop computer. Accordingly, the portable computer needs a small installation space, and can be simply carried. However, the price thereof is relatively high. Accordingly, a portable computer of reduced cost has been under development. The portable computer includes a keyboard for inputting a character, etc., and a printed circuit board supplied with power and electrically connecting various circuits. Generally, if the size of the portable computer is determined, the keyboard scarcely has alteration such as a key buttons rearrangement, a design improvement, etc. In contrast, to meet demands of users, the printed circuit board may have various alterations, and various functions may be added thereto.

FIG. 6 is a partial sectional view illustrating a part of a main body part, to which a keyboard 30 is mounted, according to a conventional portable computer. As illustrated therein, a conventional portable computer includes the keyboard 30, a printed circuit board 40, a front housing 23, a rear housing 27, and a coupling unit comprising a pem nut 60 and a pem bolt 80.

The front housing 23 and the rear housing 27 form an external appearance. The keyboard 30 is provided to an upper part of the front housing 23, and includes a plurality of key buttons (not illustrated) The printed circuit board 40 is provided between the keyboard 30 and the rear housing 27, and includes a plurality of electronic components 43 mounted thereon. The pem nut 60 and the pem bolt 80 couple the keyboard 30 to the front housing 23 and the rear housing 27, respectively.

Accordingly, the keyboard 30 can be coupled to the front housing 23 and the rear housing 27 by means of the pem nut 60 and the pem bolt 80.

However, in the conventional portable computer, the pem nut 60 of the coupling unit has a length which may penetrate the printed circuit board. If a configuration of the printed circuit board is changed to meet demands of users or to improve functionality, the keyboard becomes incapable of being coupled with the printed circuit board due to the length of the pem nut 60, or becomes restricted by the changed configuration of the printed circuit board. Accordingly, compatibility of components is deteriorated, and a configuration of the portable computer is complicated, thereby increasing a product development cost.

### SUMMARY OF THE INVENTION

The present general inventive concept provides a coupling unit and an electronic device having the same being stably assembled, improving component compatibility, reducing cost, and enhancing stability.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept can be achieved by providing an electronic device having a keyboard and a printed circuit board provided in a rear portion of the keyboard, further comprising, a housing to support the keyboard and the printed circuit board, and a coupling unit to couple the keyboard and the printed circuit board, and the coupling unit may comprise a first coupling member coupled to the keyboard to be distanced from an electronic component mounted on the printed circuit board when the keyboard and the housing are coupled together, a middle rod comprising a first coupling part provided at a first side thereof to be selectively coupled to the first coupling means, and a second coupling part provided at a second side thereof, and a second coupling member coupled with the second coupling part of the middle rod to couple the keyboard and the housing.

The first coupling member may comprise a pem nut, and the second coupling member may comprise a pem bolt.

The first coupling part of the middle rod may comprise one of a female screw and a male screw, and the second coupling part of the middle rod may comprise one of a female screw and a male screw.

The middle rod may further comprise a coupling slot formed to an end part of the second coupling part.

The housing may comprise a front housing disposed in a rear portion of the keyboard, and a rear housing coupled with the keyboard and the front housing to interpose the printed circuit board therebetween, and the front housing may comprise a nut though hole which the pem nut penetrates.

The printed circuit board may comprise a rod through hole which the middle rod penetrates, and the rear housing may comprise a bolt through hole which the pem bolt penetrates.

The electronic device may comprise a portable computer.

The foregoing and/or other aspects and utilities of the present general inventive concept may also be achieved by providing a coupling unit of an electronic device having a keyboard, a printed circuit board provided in a rear portion of the keyboard, and a housing to support the keyboard and the printed circuit board, the coupling unit to couple the keyboard and the housing, the coupling unit comprising a first coupling member to couple to the keyboard to be distanced from an electronic component mounted on the printed circuit board when the keyboard and the housing are coupled together, a middle rod comprising a first coupling part provided at a first side thereof to be selectively coupled to the first coupling member, and a second coupling part provided at a second side thereof, and a second coupling member coupled with the second coupling part of the middle rod to couple the keyboard and the housing.

The first coupling member may comprise a pem nut, and the second coupling member may comprise a pem bolt.

The first coupling part of the middle rod may comprise one of a female screw and a male screw, and the second coupling part of the middle rod may comprise one of a female screw and a male screw.

The middle rod may further comprise a coupling slot formed to an end part of the second coupling part.

The housing may comprise a front housing disposed in a rear portion of the keyboard, and a rear housing coupled with the keyboard and the front housing to interpose the printed circuit board therebetween, and the front housing may comprise a nut though hole which the pem nut penetrates.

The printed circuit board may comprise a rod through hole which the middle rod penetrates, and the rear housing may comprise a bolt through hole which the pem bolt penetrates.

The electronic device may comprise a portable computer.

The foregoing and/or other aspects and utilities of the present general inventive concept may also be achieved by providing a coupling unit of an electronic device having a keyboard and a printed circuit board, the coupling unit comprising a first coupling member removably coupled to the keyboard to distance the keyboard from the printed circuit board, and a second coupling member removably coupled to the first coupling member to couple the keyboard and the housing.

The first coupling member and the second coupling member may be coupled together at a point intersecting the printed circuit board.

The first coupling member may comprise a first coupling part comprising one of a female screw and a male screw, and a second coupling part comprising one of a female screw and a male screw.

A third coupling member may be coupled to the keyboard to couple the first coupling member to the keyboard.

The first coupling member may comprise a middle rod, the second coupling member may comprise a pem bolt, and the third coupling member may comprise a pem nut.

The foregoing and/or other aspects and utilities of the present general inventive concept may also be achieved by providing an electronic device having a keyboard and a printed circuit board provided in a rear portion of the keyboard, the electronic device comprising a housing coupled to the keyboard and the printed circuit board, wherein the keyboard and the printed circuit board are removable from the housing, and a coupling unit to removably couple the keyboard to the printed circuit board, wherein the keyboard is distanced from the printed circuit board.

The coupling unit may comprise a first coupling member to couple to the keyboard, a second coupling member to couple to the first coupling member, and a third coupling member to couple the second coupling member to the housing.

The coupling unit may comprise a pem nut to couple to the keyboard, a middle rod to couple to the pem nut, and a pem bolt to couple the middle rod to the housing.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is an exploded perspective view illustrating a portable computer according to an embodiment of the present general inventive concept;

FIG. 2 is a rear perspective view illustrating a keyboard according to an embodiment of the present general inventive concept;

FIG. 3 is a sectional view taken along line III-III in FIG. 1;

FIG. 4 is an exploded sectional view illustrating a coupling unit according to an embodiment of the present general inventive concept;

FIGS. 5A to SC are sectional views illustrating coupling processes of the coupling unit of FIG. 4 according to an embodiment of the present general inventive concept; and

FIG. 6 is a sectional view illustrating a conventional coupling unit in a conventional portable computer.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

An electronic device according to the present general inventive concept comprises an information processing device such as a television, a PDA and an MP3, and a computer. Hereinafter, a portable computer according to the present general inventive concept will be described. The portable computer may comprise all computers capable of being carried such as a laptop computer, a notebook computer, etc.

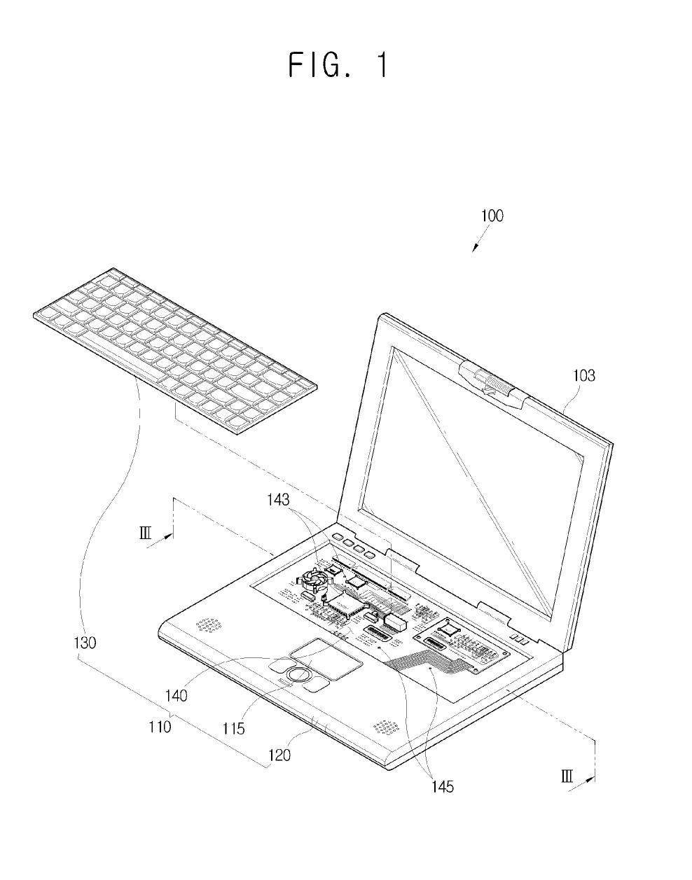

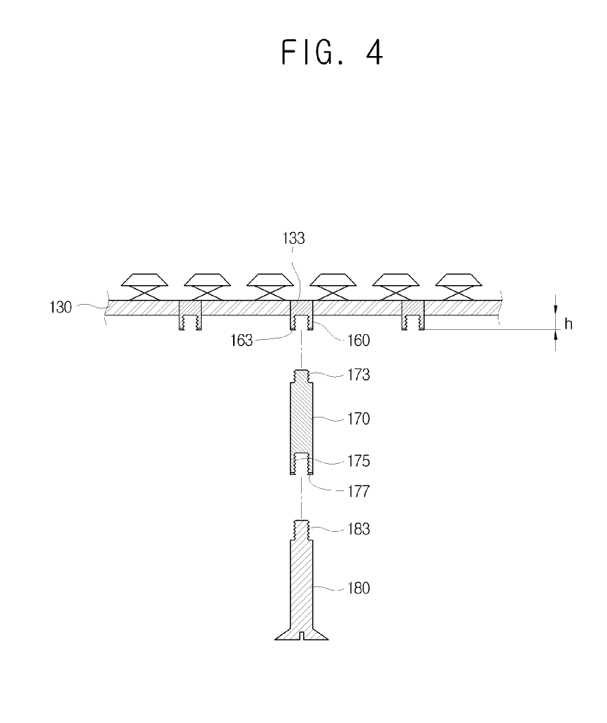

As illustrated in FIGS. 1 through 4, a portable computer 100 according to an embodiment of the present general inventive concept includes a keyboard 130, a printed circuit board 140, a main body 110 including a housing 120 and a coupling unit 150, and a display 103 rotatably coupled with the main body 110 to display an image.

Referring to FIGS. 1 to 3, the housing 120 includes a front housing 123 and a rear housing 127 disposed in a rear portion of the keyboard 130. The housing 120 forms an external appearance of the main body 110 except an area to which the keyboard 130 is mounted. In an upper area of the housing 120 are provided a touch pad 115 to move a cursor that may be displayed on the display 103, and at least one selecting button (not illustrated) to select a position of the cursor.

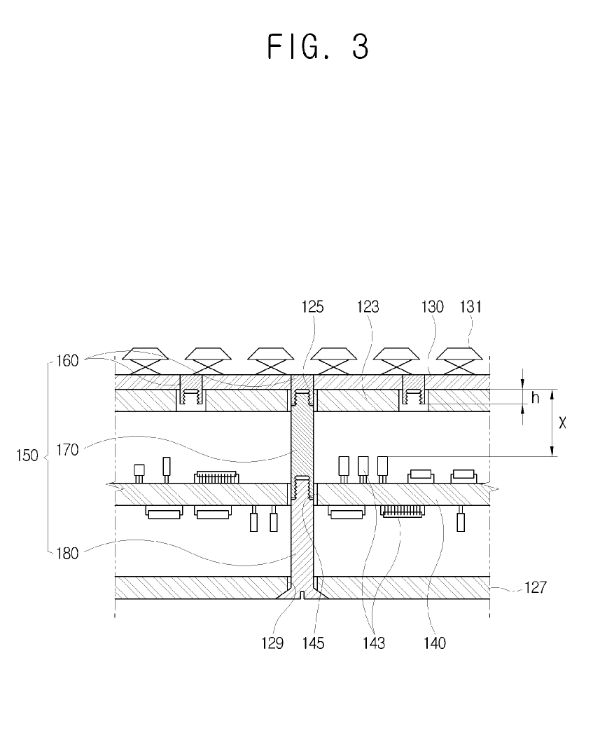

Referring to FIG. 3, the front housing 123 is disposed between the keyboard 130 and the printed circuit board 140 to support the keyboard 130 and the printed circuit board 140. The front housing 123 includes a nut through hole 125 through which a pem nut 160 coupled to the keyboard is penetrated. If the keyboard 130 has a sufficient strength, the front housing 123 may not be provided.

A rear housing 127 is coupled with the keyboard 130 and the front housing 123 to interpose the printed circuit board 140 therebetween. The rear housing 127 includes a bolt through hole 129 through which a pem bolt 180 is penetrated.

Referring to FIGS. 1 to 4, the keyboard 130 has a planar shape to mount a plurality of key buttons 131 thereon. The keyboard 130 may be formed of metal with a predetermined strength, such as aluminum. Since the keyboard 130 is formed of a thin planar member, the keyboard 130 is provided with a nut coupling hole 133 coupled with the pem nut 160 when the pem nut 160 is coupled to the keyboard 130. The pem nut 160 may be inserted to the nut coupling hole 133, thereby coupling the pem nut 160 and the keyboard 130 by pressing the pem nut 160 against the keyboard 130. The key buttons 131 are elastically mounted on a button mounted part (not illustrated) of the keyboard 130, allowing a user to directly touch the key buttons 131 to input data.

A CPU and various electronic components 143 may be mounted on the printed circuit board 140, and the electronic components 143 may be mounted on opposite sides of the printed circuit board 140. When the electronic components 143 are mounted on the printed circuit board 140, the electronic components 143 may protrude from a surface of a board main body (not illustrated). The printed circuit board 140 includes a rod through hole 145 through which a middle rod 170 penetrates. Accordingly, the printed circuit board 140 may experience a design change to meet demands of users or to correspond to various newly-added functions. Accordingly, the electronic components 143 to be mounted on the printed circuit board 140 may be added, or the position of the electronic components 143 may be changed. The position of the rod through hole 145 may be changed to change the position of the pem nut 160 to be coupled. Accordingly, the pem nut 160 that is coupled to the keyboard 130 and is not coupled with middle rod 170 may not contact the electronic components 143 of the printed circuit board 140 to not interfere therewith when the keyboard 130 and the housing 120 are coupled.

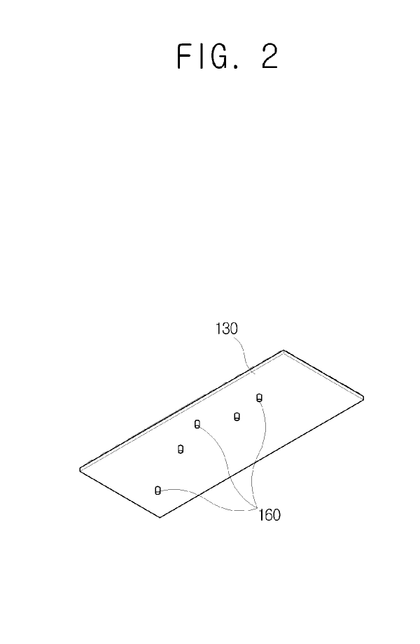

Referring to FIGS. 2 to 4, the coupling unit 150 includes a first coupling member comprising the pem nut 160, the middle rod 170, and a second coupling member comprising the pem bolt 180.

A plurality of pem nuts 160 are positioned at a certain distance from the electronic components 143, and are mounted on the printed circuit board 140 to couple the keyboard 130 with the housing. A first side of the pem nut 160 is coupled to the nut coupling hole 133 of the keyboard 130, and a second side of the pem nut 160, which is referred to as a first rod coupling part 163, is coupled with a first coupling part 173 of the middle rod 170. There may be more pem nuts 160 than middle rods 170. The pem nut 160 may be disposed to a rear surface of the keyboard 130 to consider any future design changes or developments of the printed circuit board 140. Referring to FIG. 3, the height “h,” which extends from the rear surface of the keyboard 130 to an end part of the pem nut 160, should be smaller than the height “X,” which extends from the rear surface of the keyboard 130 to the electronic components 143 mounted on a surface of the printed circuit board 140. Accordingly, the pem nut 160 that is not coupled with the middle rod 170 does not contact the electronic components 143 and does not interfere therewith. Thus, even if the printed circuit board 140 has a design change, the keyboard 130 that is provided with the pem nut 160 can correspond to a changed printed circuit board (not illustrated) and be coupled.

The first coupling part 173 is provided as a female screw, but may also be provided as a male screw. The first coupling part 173 may have a predetermined pitch to maintain a coupling strength against the middle rod 170. Accordingly, the keyboard 130 can be standardized to reduce a stock cost, to make repair or replacement thereof easier, and to reduce product development time and cost.

The middle rod 170 includes the first coupling part 173 provided to a first side thereof to be selectively coupled to the pem nut 160, and a second coupling part 175 provided to a second side thereof to be coupled to the pem bolt 180. The middle rod 170 may be singly provided when the size of the keyboard 130 is small. The middle rod 170 may also be provided in plurality. The middle rod 170 is coupled to the keyboard 130 to penetrate the rod through hole 145 of the printed circuit board 140. The middle rod 170 may have such a length as to penetrate the rod through hole 145 of the printed circuit board 140 to be adjacent to the rear housing 127. The first coupling part 173 of the middle rod 170 is provided as a male screw, and the second coupling part 175 is provided as a female screw. Alternatively, the first coupling part 173 and the second coupling part 175 may be provided as either a female screw or a male screw to correspond to the first rod coupling part 163 and a second rod coupling part 183. The middle rod 170 includes a coupling slot 177 having “−” shape or “+” shape formed to an end part of the second coupling part 175. Accordingly, the middle rod 170 is easily coupled to the pem nut 160 by coupling a tool such as a screwdriver to the coupling slot 177. Alternatively, the middle rod 170 may be coupled with the pem nut 160 and the pem bolt 180 by a pressurizing coupling part or other coupling means to maintain a predetermined coupling strength.

Accordingly, the middle rod 170 can be selectively coupled to the pem nut 160 to optimize the strength of the keyboard 130, thereby preventing the keyboard 130 from moving to enhance stability Also, since the middle rod 170 is coupled with the pem nut 160 to penetrate the rod through hole 145 of the printed circuit board 140, the printed circuit board 140 and the keyboard 130 can maintain their positions with respect to each other without moving when the printed circuit board 140 and the keyboard 130 are assembled.

The pem bolt 180 is coupled with the second coupling part 175 of the middle rod 170 to couple the keyboard 130 and the housing 120. The pem bolt 180 penetrates the bolt through hole 129 of the rear housing 127 to be coupled with the second coupling part 175 of the middle rod 170.

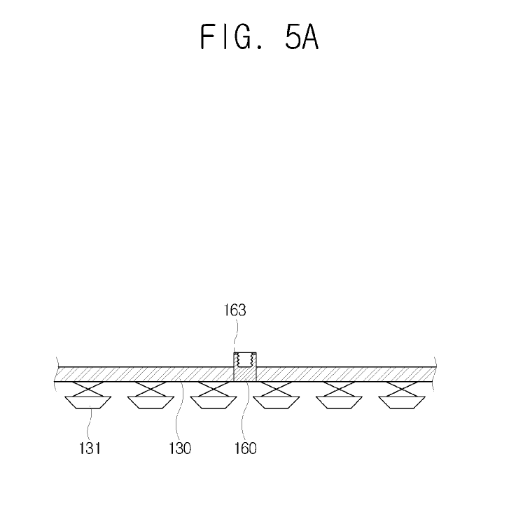

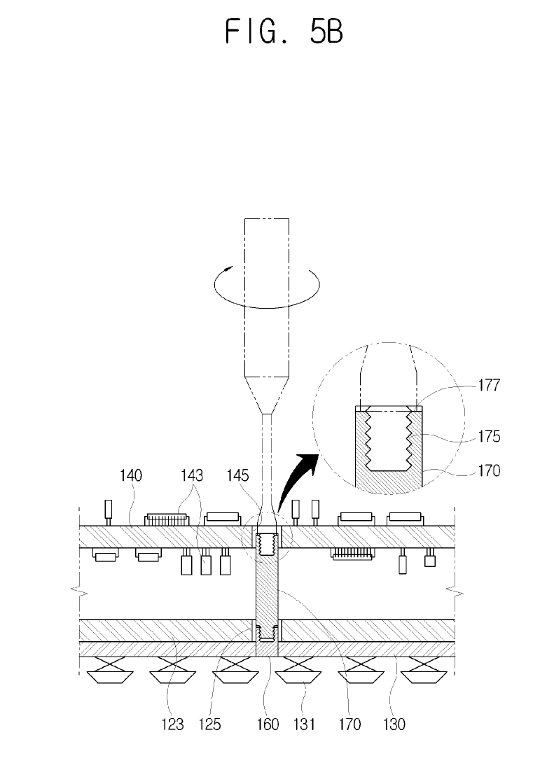

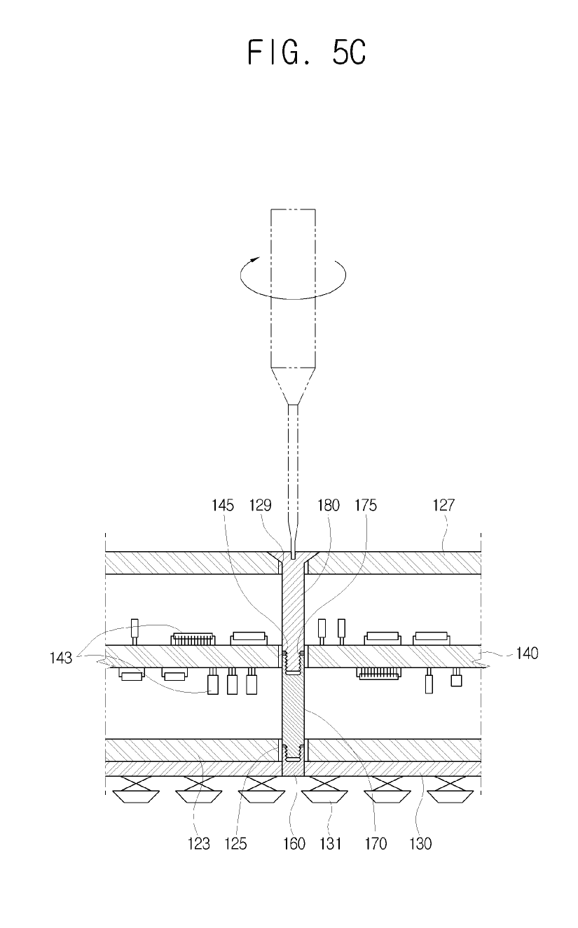

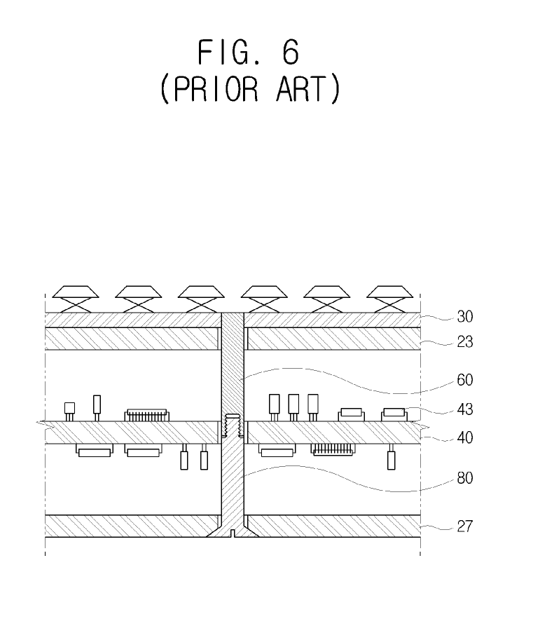

Hereinafter, a coupling process of the portable computer 100 including the coupling unit 150 of FIGS. 1-4 will be described while referring to FIGS. 5A through 5C.

Referring to FIG. 5A, the keyboard 130 is positioned on a worktable so that the key buttons 131 face downward to allow the first rod coupling part 163 of the pem nut 160 to face upward.

Referring to FIGS. 5A and 5B, the nut through hole 125 is positioned to correspond to the pem nut 160 of the keyboard 130, and the front housing 123 is positioned on an upper side of the keyboard 130. The middle rod 170 may be selectively coupled to the pem nut 160. The middle rod 170 may be coupled to the pem nut 160 by inserting a tool such as a screw driver into the coupling slot 177 of the middle rod 170, and screwing the middle rod 170 to the pem nut 160. The coupling slot 177 may be coupled with the second coupling part 175. The rod through hole 145 may be positioned to correspond to the middle rod 170, and the printed circuit board 140 and the electric components 143 may be positioned on an upper side of the front housing 123. Accordingly the middle rod 170 may be inserted into the rod through hole 145 of the printed circuit board 140, and the keyboard 130 and the printed circuit board 140 can maintain their positions with respect to each other without moving. Here, the pem nut 160, which is not coupled with the middle rod 170, does not contact the printed circuit board 140 nor interfere therewith.

Referring to FIGS. 5A through 5C, the rear housing 127 is positioned on an upper side of the printed circuit board 140 to correspond to the front housing 123. The pem bolt 180 is coupled with the second coupling part 175 of the middle rod 170 through the bolt through hole 129 of the rear housing 127 from an upper side.

According to the present general inventive concept, the middle rod is selectively coupled to a pem nut in a state that a keyboard and a housing are coupled, thereby standardizing a component such as the keyboard, and reducing costs corresponding to inventory management, repair, product development, etc. Also, a middle rod is selectively coupled to a pem nut to optimize strength of a keyboard, thereby preventing the keyboard from moving, and enhancing stability. Also, a printed circuit board and a keyboard maintain their positions with respect to each other without moving when being assembled, thereby being stably assembled.

As described above, a coupling unit and an electronic device having the same according to the present general inventive concept can standardize a component such as a keyboard to reduce costs.

Also, a coupling unit and an electronic device having the same according to the present general inventive concept can prevent a keyboard from moving when being used, thereby enhancing stability.

Also, a coupling unit and an electronic device having the same according to the present general inventive concept can be stably assembled.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electronic device having a keyboard and a printed circuit board provided in a rear portion of the keyboard, the electronic device comprising:
a housing to support the keyboard and the printed circuit board; and
a coupling unit to couple the keyboard and the printed circuit board, the coupling unit comprising;
a first coupling member coupled to the keyboard to be distanced from an electronic component mounted on the printed circuit board when the keyboard and the housing are coupled together,
a middle rod comprising:
a first coupling part provided at a first side thereof to be selectively coupled to the first coupling member, and
a second coupling part provided at a second side thereof, and
a second coupling member coupled with the second coupling part of the middle rod to couple the keyboard and the housing.

2. The electronic device according to claim 1, wherein:
the first coupling member comprises a pem nut; and
the second coupling member comprises a pem bolt.

3. The electronic device according to claim 1, wherein:
the first coupling part of the middle rod comprises one of a female screw and a male screw; and
the second coupling part of the middle rod comprises one of a female screw and a male screw.

4. The electronic device according to claim 3, wherein the middle rod further comprises:
a coupling slot formed to an end part of the second coupling part.

5. The electronic device according to claim 2, wherein the housing comprises.
a front housing disposed in rear of the keyboard, having a nut through hole which the pem nut penetrates; and
a rear housing coupled with the keyboard and the front housing to interpose the printed circuit board therebetween.

6. The electronic device according to claim 5, wherein:
the printed circuit board comprises a rod through hole which the middle rod penetrates; and
the rear housing comprises a bolt through hole which the pem bolt penetrates.

7. The electronic device according to claim 1, wherein the electronic device comprises a portable computer.

8. A coupling unit of an electronic device having a keyboard, a printed circuit board provided in a rear portion of the keyboard, a housing to support the keyboard and the printed circuit board, the coupling unit to couple the keyboard and the housing, the coupling unit comprising:
a first coupling member coupled to the keyboard to be distanced from an electronic component mounted on the printed circuit board when the keyboard and the housing are coupled together;
a middle rod comprising:
a first coupling part provided at a first side thereof to be selectively coupled to the first coupling means, and
a second coupling part provided at a second side thereof; and
a second coupling member coupled with the second coupling part of the middle rod to couple the keyboard and the housing.

9. The coupling unit according to claim 8, wherein:
the first coupling member comprises a pem nut; and
the second coupling member comprises a pem bolt.

10. The coupling unit according to claim 8, wherein:
the first coupling part of the middle rod comprises one of a female screw and a male screw; and
the second coupling part of the middle rod comprises one of a female screw and a male screw.

11. The coupling unit according to claim 10, wherein the middle rod further comprises:
a coupling slot formed to an end part of the second coupling part.

12. The coupling unit according to claim 9, wherein the housing comprises:
a front housing disposed in rear of the keyboard having a nut through hole which the pem nut penetrates; and
a rear housing coupled with the keyboard and the front housing to interpose the printed circuit board therebetween.

13. The coupling unit according to claim 12, wherein:
the printed circuit board comprises a rod through hole which the middle rod penetrates; and
the rear housing comprises a bolt through hole which the pem bolt penetrates.

14. The coupling unit according to claim 8, wherein the electronic device comprises a portable computer.

15. A coupling unit of an electronic device having a keyboard and a printed circuit board, the coupling unit comprising:
a first coupling member removably coupled to the keyboard to distance the keyboard from the printed circuit board; and
a second coupling member removably coupled to the first coupling member to couple the keyboard and the housing.

16. The coupling unit of claim 15, wherein:
the first coupling member and the second coupling member are coupled together at a point intersecting the printed circuit board.

17. The coupling unit of claim 15, wherein the first coupling member comprises:
a first coupling part comprising one of a female screw and a male screw; and
a second coupling part comprising one of a female screw and a male screw.

18. The coupling unit of claim 15, further comprising:
a third coupling member coupled to the keyboard to couple the first coupling member to the keyboard.

19. The coupling unit of claim 18, wherein:
the first coupling member comprises a middle rod;
the second coupling member comprises a pem bolt; and
the third coupling member comprises a pem nut.

20. An electronic device having a keyboard and a printed circuit board provided in a rear portion of the keyboard, the electronic device comprising:
a housing coupled to the keyboard and the printed circuit board, wherein the keyboard and the printed circuit board are removable from the housing; and
a coupling unit to removably couple the keyboard to the printed circuit board, wherein the keyboard is distanced from the printed circuit board.

21. The electronic device of claim 20, wherein the coupling unit comprises:
a first coupling member to couple to the keyboard;
a second coupling member to couple to the first coupling member; and
a third coupling member to couple the second coupling member to the housing.

22. The electronic device of claim 20, wherein the coupling unit comprises:
a pem nut to couple to the keyboard;
a middle rod to couple to the pem nut; and
a pem bolt to couple the middle rod to the housing.
